(19) United States
(12) Patent Application Publication
(10) Pub. No.: US 2011/0254271 A1
(43) Pub. Date: Oct. 20, 2011

(54) Tidal Turbine System

(76) Inventors: Christopher Freeman, Nottingham (GB); Christopher Williams, Vale of Galmorgan (GB)

(21) Appl. No.: 12/999,681

(22) PCT Filed: Jun. 19, 2009
(86) PCT No.: PCT/GB2009/001548

§ 371 Date: Mar. 22, 2011

(30) Foreign Application Priority Data
Jun. 23, 2008 (GB) 0811489.4

(51) Int. Cl. F03B 13/26; F03B 13/18

(52) U.S. Cl. 290/42; 60/502

(57) ABSTRACT

A tidal flow turbine system has a rotor and turbine blades attached at a fixed attitude with respect to the rotor and extending outwardly from the rotor. The stagger angle of the blades, tip speed ratio, or other blade parameters is such that over the in-service operational speed range of the turbine, over a lower range of rotational or tidal flow speeds, increased speed results in increased axial loading on the turbine, but at higher speed range above a predetermined threshold, axial loading on the turbine does not increase.

The present invention relates to a tidal turbine system, particularly for use in a tidal flow energy generation system.

### BACKGROUND OF THE INVENTION

Tidal energy is to a great extent predictable. At depths below significant wave effects the only basic changes in current flow are due the naturally occurring phases of the moon and sun. Superimposed on this pattern is a variation of flow velocities, some reaching a considerable fraction of the free-stream values, and which are due to intense atmospheric events.

The deterministic nature of the availability of power, together with its high density and the implicit absence of visual impact makes tidal energy extraction a very attractive proposition particularly since virtually the whole of the available resources remain untapped.

A number of tidal turbine schemes have been proposed with a division being between those which require the setting of sea floor foundations and those which do not. A free standing framework design has been developed which rests on the sea bed and supports multiple turbines. The design benefits from an overarching simplicity of construction and implementation which offers, through the absence of complex failure-prone mechanisms, high inbuilt reliability.

Known tidal turbine designs have adopted a variable pitch blade approach along the lines of what is commonly done in the wind turbine industry. Turbines fitted with variable pitch blades are known to be marginally less efficient than those employing a fixed pitch at its best efficiency point. Nevertheless since variable pitch turbines retain a comparatively high efficiency in a range of flow speeds away from the best efficiency point of a comparable fixed pitch design that method yields a better overall power extraction performance than fixed pitch turbines. Variable pitch blade turbines have also better start up characteristics.

In addition they can cope with very high speeds of the medium from whence they extract power, wind or tidal currents, and have an inherent capability of being slowed down and stopped when flow conditions become extreme through a variation in pitch (stalling) and by feathering the blades.

Fixed pitch turbines require different methods of over-speed control in order to prevent a runaway condition at high flow regimes. The conventional approach is either through the provision of some form of blade stall, through the furling of the turbine, i.e. by swinging the turbine away from the incoming flow onto a “sideways position”, or by slowing or stopping the rotor via mechanical, electrical or electro-mechanical means.

The control of over-speed control for tidal turbines, particularly for turbines operating on free standing structures, is needed to limit the rapid rise in axial loads that arise from operation at high flows and/or in freewheeling conditions. Overloading could otherwise cause the supporting structure to shift on the seabed. This is a situation which it is important to avoid for many reasons. Over speed control also limits the centrifugal stresses and related torsional and flapping stresses that can be induced in the blades of a fast rotating rotor.

### SUMMARY OF THE INVENTION

According to a first aspect, the present invention provides a tidal flow turbine system comprising a rotor and a plurality of turbine blades at a fixed attitude with respect to the rotor and extending outwardly from the rotor; wherein the blades are configured such that over the in-service operational speed range of the turbine, over a lower range of rotational and or tidal flow speeds, increased speed results in increased axial loading on the turbine, but at higher speed range above a predetermined threshold, axial loading on the turbine does not increase.

Beneficially, one or more parameters of the blade are selected or tailored to ensure that over the in-service operational speed range of the turbine, over a lower range of rotational speeds, increased rotational speed results in increased axial loading on the turbine, but at higher speed range above a predetermined threshold, axial loading on the turbine does not increase (or alternatively decreases).

The parameters that are selected or tailored are the blade stagger angle and/or the Tip Speed Ratio (TSR). The stagger angle refers to the angle of attack or pitch of the blade with respect to the tidal flow direction.

In a preferred realisation of the invention, at the higher speed range above the predetermined rotational or tidal flow speed threshold, the axial loading on the turbine actually decreases (significantly—by 5% or more or 10% or more). It is preferred therefore that the threshold comprises a peak thrust loading after which the thrust falls off significantly.

It is preferred that the blade design of the turbine is arranged to ensure that the maximum axial rotational load is exerted at a rotational speed below the freewheeling speed of the rotor.

In the operation service range expected the peak thrust loading is designed to be at tidal flow speeds in the range 2.5 m/s to 5 m/s. The decrease in the thrust loading above the threshold provides a failsafe preventing over-thrust loading of the mounting structure in freewheeling, grid failure or other electrical load reduction events.

The tidal flow turbine system may include a mounting structure located on the sea bed, the mounting structure being parked in position by its own weight and secured against displacement primarily by frictional contact with the seabed.

It is preferred that the blade design of the turbine is arranged to ensure that the peak power coefficient and peak thrust coefficient are at substantially the same value of tip speed ratio. Beneficially, the peak power coefficient and peak thrust coefficient are at a value of tip speed ratio within 10% of one another.

Beneficially the blade stagger angle selection comprises the primary fail safe or over-speed cut out facility for the tidal flow turbine system. As such other more complex and additional braking systems are not required, nor complex control systems for ensuring adequate braking or fail safe in adverse conditions.

In a preferred embodiment, the tidal turbine system includes an interconnected framework structure arranged to rest on the seabed and support a plurality of spaced turbine generators.

According to an alternative aspect, the invention provides a method of controlling the speed of a rotational tidal turbine rotor using fixed attitude blades at a predetermined stagger angle.

The stagger angle, TSR or other parameters of the blades is typically arranged such that over the in-service operational speed range of the turbine, over a lower range of rotational or tidal flow speeds, increased speed results in increased axial loading on the turbine, but at higher speed range above a predetermined threshold, axial loading on the turbine does not increase (or decreases significantly to a thrust load level below the threshold).

In an alternative aspect, the invention resides in a control or braking system for a tidal flow turbine generator comprising a rotor and a plurality of turbine blades at a fixed attitude with respect to the rotor and extending outwardly from the rotor; wherein the stagger angle of the blades, TSR or other blade design parameters is arranged such that over the in-service operational speed range of the turbine, over a lower range of rotational or tidal flow speeds, increased speed results in increased axial loading on the turbine, but at higher speed range above a predetermined threshold, axial loading on the turbine does not increase (or decreases significantly to a thrust load level below the threshold).

The invention also encompasses a design method for designing a tidal flow turbine system comprising a rotor and a plurality of turbine blades at a fixed attitude with respect to the rotor and extending outwardly from the rotor; wherein the stagger angle of the blades is selected such that over the in-service operational speed range of the turbine, over a lower range of rotational speeds, increased rotational speed results in increased axial loading on the turbine, but at higher speed range above a predetermined threshold, axial loading on the turbine does not increase.

The invention will now be described in a specific embodiment, by way of example only, and with reference to the accompanying drawings.

### BRIEF DESCRIPTION OF THE DRAWINGS

FIG. 1 is a schematic representation of a tidal flow turbine system in accordance with the invention;

FIG. 2 is a plot of axial loading vs rotor speed for a conventional turbine;

FIG. 3 is plot of Power Coefficient and Thrust coefficient vs Tip speed ratio for the system of the invention for 7 different blade staggers.

FIG. 4 is a plot of Power Coefficient and Thrust Coefficient vs Tip Speed Ratio for the system of the invention designed to maximise thrust control and a system designed to maximise efficiency;

FIG. 5 is a plot of axial thrust versus tidal current flow for an exemplary system in accordance with the invention.

FIGS. 6 and 7 are schematic velocity and force diagrams underlying the theory of the present invention.

### DETAILED DESCRIPTION OF THE PREFERRED EMBODIMENTS

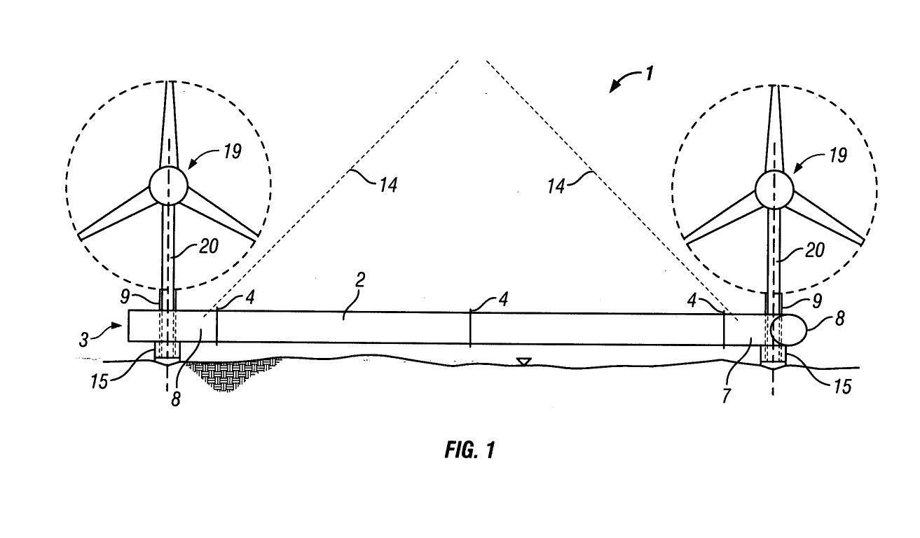

Referring to the drawings, and initially to FIG. 1 there is shown a tidal flow energy generation arrangement 1. The tidal flow energy generation arrangement 1 is required to be operated in extreme conditions. To be commercially competitive with other forms of power production areas of the seabed of high tidal flow energy concentration need to be utilised. These areas are difficult and dangerous to work in and the structure and its installation and retrieval need to take into account significant environmental hazards. The current flow, for example, is fast, typically upward of 4 Knots. Areas are often in deep water, which may be deeper than those in which a piling rig can operate. Storm conditions can cause costly delays and postponement. Tidal reversal is twice a day and the time between tidal reversal may be very short (for example between 15 and 90 minutes). Additionally, in such high tidal flow areas, the seabed is often scoured of sediment and other light material revealing an uneven rock seabed, which makes anchorage difficult. In the situations described it may be impossible for divers or remote operated vehicles to operate on the structure when positioned on the seabed. Installation, recovery and service is therefore most conveniently carried out from the surface. To be environmentally acceptable, all parts of the structure and any equipment used in deployment or recovery must be shown to be recoverable.

The arrangement 1 comprises a freestanding structural frame assembly comprising steel tubes 2 (circa 1.5 m diameter). The frame assembly comprises welded tubular steel corner modules 3. The corner units are interconnected by lengths of the steel tubes 2. The structure as shown in the drawings is triangular in footprint and this may for certain deployment scenarios be preferred however other shape footprints (such as rectangular) are also envisaged in such arrangements the angular configuration of the corner modules 3 will of course be different to that shown and described in relation to the drawings.

The corner modules 3 comprise first and second angled limbs 7, 8 extending at an angle of 60 degrees to one another. The angled tube limb 7 is welded onto the outer cylindrical wall of limb 8. Angled tube limbs 7 and 8 are fixed to a respective nacelle tower 9. The corner module 3 and interconnecting tubes 2 include respective flanges 4 for bolting to one another. The tube limb 8 of the corner modules include a flap valve comprising a hinged flap closing an aperture in a baffle plate welded internally of the end of tube limb 8. Water can flood into and flow out of the tube limb 8 (and therefore into the tubes 2) via the flap valve. Once flooded and in position on the seabed, the flap valve tends to close the end of the tube limb 8 preventing silting up internally of the tubular structure.

The corner modules 3 also include a structural steel plate (not shown) welded between the angled tubular limbs 7, 8. A lifting eye structure is welded to the steel plate. An end of a respective chain 14 of a chain lifting bridle arrangement is fixed to the lifting eye. A respective lifting chain 14 is attached at each node module 3, the distal ends meeting at a bridle top link. In use a crane hook engages with the top link for lifting. Self levelling feet 15 maybe provided fore each of the corner modules 3. This ensures a level positioning of the structure on uneven scoured seabed and transfer of vertical loadings directly to the seabed.

The structure is held in position by its own mass and lack of buoyancy due to flooding of the tubes 2 and end modules 3. The tubes 2 are positioned in the boundary layer close to the seabed and the structure has a large base area relative to height. This minimises potential overturning moment. Horizontal drag is minimised due to using a single large diameter tubes 2 as the main interconnecting support for the frame.

The structure forms a mounting base for the turbines 19 mounted at each corner module 3, the support shaft 20 of a respective turbine 19 being received within the respective mounting tube 3 such that the turbines can rotate about the longitudinal axis of the respective support shaft 20. Power is transmitted from the corner mounted turbines 19 to onshore by means of appropriate cable as is well known in the marine renewables industry.

Areas of deep water and high current and low visibility are very hazardous for divers. The structure is designed to be installed and removed entirely from surface vessels. The structure is designed to be installed onto a previously surveyed site in the time interval that represents slack water between the ebb and flood of the tide. This time may vary from 15 to 90 minutes. The unit may be restricted from being deployed outside the timeframe as the drag on the structure from water movement could destabilise the surface vessel.

In times of extremely high tidal flow velocities, there is a risk with a freestanding structure of this type that the axial loading on the turbines 19 can be so high that the structure could shift on the underlying seabed. This would have numerous undesirable consequences, including tension being placed on cables and the like.

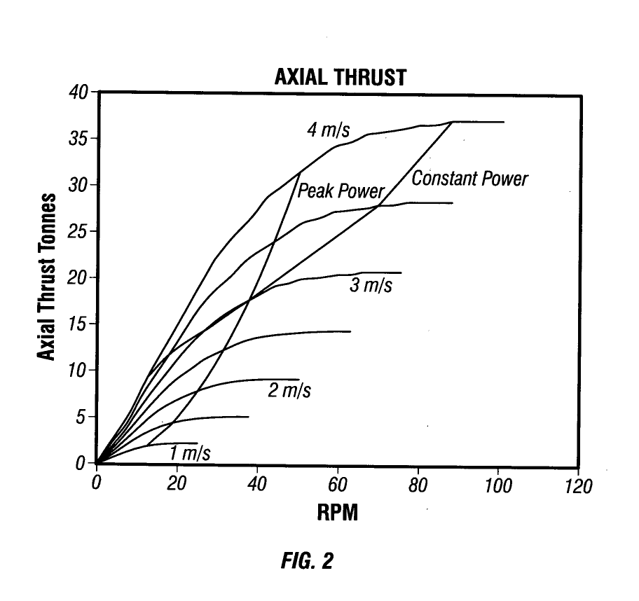

Conventionally designed turbine blades for tidal power conversion, exhibit a steady increase in axial loading as the tip speed increases. This situation is graphically described in FIG. 2 where the variation of axial thrust is plotted in terms of rotor rotational speed.

This rotational speed increase may be related to an increase of the speed of the incoming flow, both in the form of a momentary spike or when the tidal current cycles through the highest values. Alternatively the turbine rotational speed increase may be associated with a reduction of the torque load presented by the generator or indeed by a cessation of that load altogether.

In accordance with the turbine design of the invention, the blade stagger angle and the choice of blade profiles are combined in a manner such as to decrease the axial thrust when a selected power output is attained. In this way a fixed pitch turbine can exert its maximum axial loading on the supporting structure not as the rotational speed increases, to attain a maximum in a freewheeling condition, as a conventionally designed fixed pitch turbine would operate, but around a predetermined rotational speed.

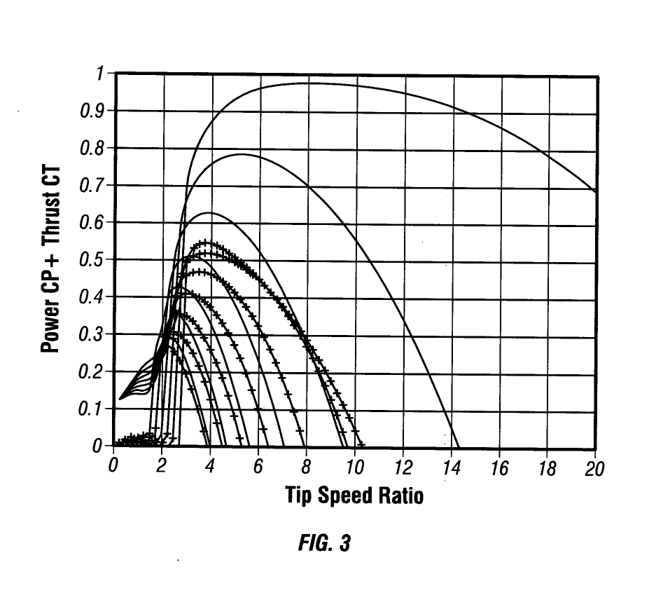

FIG. 3 shows the relationship between two quantities, power coefficient, Cp, and thrust coefficient, Ct, against the turbine tip speed ratio. The tip turbine speed ratio is the tip speed divided by the tidal flow speed. It has been established that for a fixed pitch tidal flow turbine, blade design can produce a combined Cp/Ct behaviour that leads to a significant thrust decrease beyond a peak value, in contrast with generic behaviour in respect of designs optimised to power generation efficiency.

In FIG. 3 the Cp-e and Ct-e curves represent a design optimised for efficiency maximisation. The Cp-t and Ct-t curves represent a design optimised for thrust control. The values shown in respect of FIG. 3 are chosen to exemplify the difference between the 2 design paradigms. It can be seen that when the maximum rated tip speed ration is reached there is a significantly greater and more rapid/steep fall of for the Ct-t curve than for the Ct-e curve.

The employment of the Ct-t thrust control paradigm is envisaged in circumstances in which a power shedding strategy is employed such that the turbine is permitted to speed up when the tidal flow velocity exceeds the value associated with the maximum design Cp. A second situation corresponds to a failure of the control system in which a freewheeling condition might arise and where it is envisaged that a turbine whose thrust reduces with increasing tip speed, at least initially, would impart an element of fail safe nature to the design.

This is particularly important where the seabed mounting structure requires on friction/gravity solely to retain the structure parked in the correct position on the seabed. A design requirement in such a situation is that the freewheeling thrust should not exceed the frictional force with the highest tidal velocity. The present invention enables the turbine to operate at peak Cp as tidal velocity increases until the power reaches the rated power. When the tidal velocity exceeds the peak rated value, the power may be held constant whilst the thrust falls initially (until at a very high tidal speed it may begin to rise again).

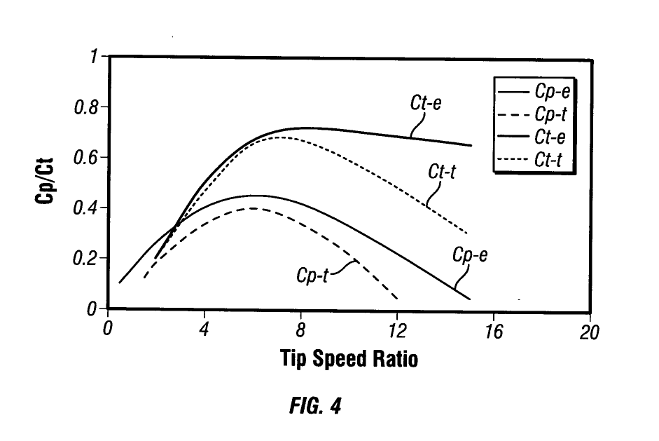

An important consideration in designing the turbine blade system relates to identifying the appropriate TSR and stagger angle to achieve the desired power shedding characteristics. Calculations were made for a range of two dimensional designs at differing blade tip staggers over a range of TSRs from 2 degrees stagger to 14 degrees stagger at 2 degree intervals. The results are shown in FIG. 4 where the power coefficient Cp is denoted by + signs whilst the continuous line represents the thrust coefficient, for the 7 different stagger angles from 2 to 14 degrees. The stagger quoted is the angle of the aerofoil to the tangential direction. It can be seen that at lower stagger values, the thrust is higher when the turbine is unloaded than when it is loaded and therefore high TSR values are not desirable give that, should a grid connection fail, there would be an increase of thrust.

As can be seen from FIG. 4, as the stagger angle increases and TSR fall, the ratio of Ct/Cp max falls and so the drag for a given power falls. Also the drag at no load falls and the speed increase from full power to no power reduces. Low TSR has benefits for tidal power generators. Cavitation issues are improved since larger blade chords and low relative velocity offer a static pressure reduction and hence reduce the potential for cavitation. Similarly the blade unsteady response will be reduced by the lower reduced blade frequency (f C/Vrel) sine C increases whilst Vrel is reducing.

The blade stagger and TSR is selected such that the peaks of power and thrust coefficients (Cp and Ct) will substantially coincide enabling the turbine to operate in a safe manner when the system becomes disconnected from a power source, at the required flow velocities.

This approach enables the dispensing of elaborate and/or costly fail-safe variable pitch, stagger blades, stalling, braking or furling mechanisms while retaining the inherent simplicity and robustness of a fixed pitch/stagger turbine.

Unlike with conventional turbine designs, the drag on the structure decreases with increased rotational speed, above a predetermined threshold. The predetermined threshold about which performance is designed will be dependent upon various factors such as tidal flow velocities, blade size, structure weight and drag etc.

Since the turbine arrangement of the present invention has an inbuilt drag reduction quality this enables the usage of larger diameters to be used without a drag penalty at higher flows. Consequently the turbine is capable of capturing more of the lower speed flow energy in the tidal currents.

The turbine dispenses the need for elaborate fail-safe over-speed protection measures, in contrast to conventional designs.

The methodology requires the turbine and blade system design to be tailored to specific parameters including the mounting structure weight, the peak tidal flow rates, thrust loading etc. The rotor and blade design is achieved by using throughflow calculations to derive flow velocities and Prandtl Tip loss factor techniques to enable the blade geometry to be defined. For a given change in tangential velocity a series of designs for a rage of TSR and mean blade chord can be investigated and allow the design meeting the optimum criteria for thrust control to be selected. In one example a TSR selection is based on lowest drag/power ratio. In the example for a tidal flow of 3 m/s the optimum drag/power ratio occurs with a TSR of 3.2 and a chord of 1.8 metres for a nominal 15 meter diameter three blade turbine. The highest value of CP occurred with a TSR of just over 5.

In aerofoil design it is usual for the blades to have a camber as this generally increases the circulation or blade efficiency. The ratio of lift coefficient (Cl) and drag coefficient (Cd) is a measure of this, the value increasing for a cambered blade. In a refinement of the present invention an un-cambered blade may beneficially be used to minimise the power-off thrust and blade stalling problems at high tidal flows when the blades are unloaded and running at higher revolutions per minute (RPM).

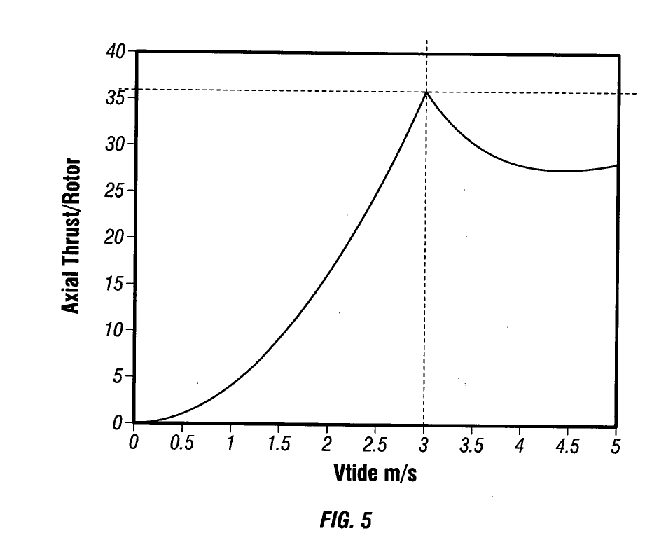

FIG. 5 is a plot of axial thrust versus tidal current flow for an exemplary system in accordance with the invention. As can be seen the design is selected such that the power shed threshold is set at 3 m/s. After the 3 m/s tidal flow threshold is reached there is a rapid drop off in axial thrust loading. The threshold has a marked peak. The blade design is selected such that the threshold or peak is generally in the range 2.5 m/s to 5 m/s for most operational situations.

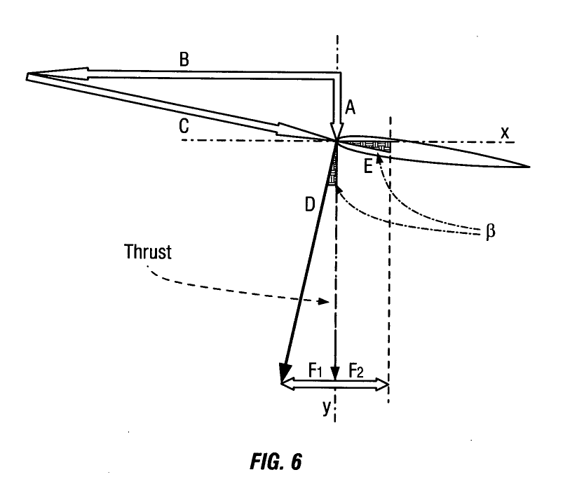

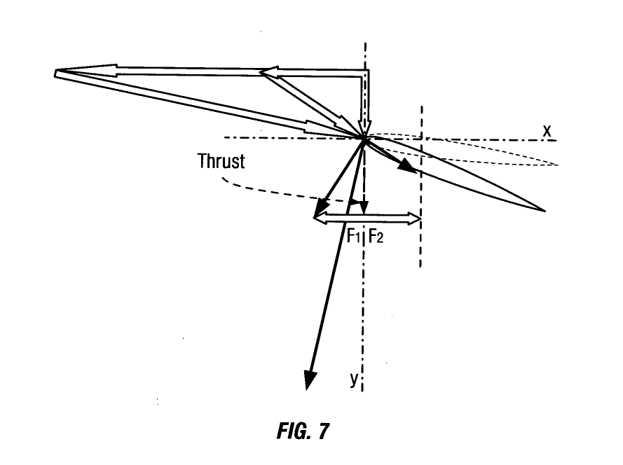

Some of the underlying theory behind the present invention is now described in relation to FIGS. 6 and 7. The position of the vectors denoting the different velocities (bold arrows) and resultant forces is shown in FIG. 6. The velocities are, A the tidal flow velocity, B the rotation velocity and C the blade-relative flow velocity. The lift force is represented by D while the drag force is marked as E in this figure.

These two forces can be expressed as forces in the Cartesian directions, x and y along which the turbine torque and the axial thrust, respectively, are seen to act.

The conversion of the lift and drag into torque and thrust is done by reference to the identical angles denoted as β in the same figure.

The freewheeling condition is represented vectorially by the forces, F₁ and F₂, which are the resolved components along the X axis of the thrust and drag forces. Since the freewheeling situation corresponds to an equilibrium state, the F₁ and F₂ forces are equal and opposite.

The fundamental elements of FIG. 6 are replicated in FIG. 7. In FIG. 7 are also shown the three velocity components, A, B and C, the blade profile in a high stagger position, the components of thrust and drag and the F₁ and F₂ forces.

The tide flow velocity is the same for both sketches, velocity A. Given the higher work produced by the increased stagger the rotational velocity, B, is decreased. The sketches are conceptual and hence the magnitudes of the various forces need not be drawn to scale.

What is readily apparent is that any increase in the stagger of the blade profile will be accompanied by a sizeable reduction in the axial thrust of the turbine. This is brought about by the fact that the component of the lift force when projected along y is much smaller for the high stagger blade.

The freewheeling condition represented by the balancing of the F₁ and F₂ forces corresponds therefore to a much reduced turbine loading in the direction of the flow by comparison to conventional design.

1. A tidal flow turbine system comprising:
a rotor and a plurality of turbine blades at a fixed attitude with respect to the rotor and extending outwardly from the rotor; wherein the blades are configured such that over the in-service operational speed range of the turbine, over a lower range of rotational and or tidal flow speeds, increased speed results in increased axial loading on the turbine, but at a higher speed range above a predetermined threshold, axial loading on the turbine does not increase.

2. A tidal flow turbine system according to claim 1, wherein:
at the higher speed range above the predetermined threshold, axial loading on the turbine decreases.

3. A tidal flow turbine system according to claim 1, wherein:
one or more parameters of the blade are selected to ensure that over said lower range of rotational speeds, increased rotational speed results in increased axial loading on the turbine, but at said higher speed range above said predetermined threshold, axial loading on the turbine does not increase.

4. A tidal flow turbine system according to claim 3, wherein:
the one or more parameters of the blade are selected from the group including blade stagger angle and Tip Speed Ratio (TSR).

5. A tidal flow turbine system according to claim 1, wherein:
the maximum axial load is exerted at a rotational speed below the freewheeling speed of the rotor.

6. A tidal flow turbine system according to claim 1, wherein:
the threshold comprises a peak thrust loading after which the thrust falls off significantly.

7. A tidal flow turbine system according to claim 6, wherein:
the peak thrust loading is designed to be at tidal flow speeds in the range 2.5 m/s to 5 m/s.

8. A tidal flow turbine system according to claim 1, further comprising:
a mounting structure located on the seabed, the mounting structure being parked in position by its own weight and secure against displacement primarily by frictional contact with the seabed.

9. A tidal flow turbine system according to claim 8, wherein:
the control of axial loading on the turbine loading above the threshold provides a failsafe preventing over-thrust loading of the mounting structure in freewheeling, grid failure or other electrical load reduction events.

10. A tidal flow turbine system according to claim 1, wherein:
a peak power coefficient of the turbine and a peak thrust coefficient of the turbine are at substantially the same value of a tip speed ratio of the turbine.

11. A tidal flow turbine system according to claim 10, wherein:
the peak power coefficient and the peak thrust coefficient are at a value of the tip speed ratio within 10% of one another.

12. A tidal flow turbine system according to claim 4, further comprising:
a primary breaking system for selecting blade stagger angle of the tidal flow turbine system.

13. A tidal flow turbine system according to claim 1, further comprising:
an interconnected framework structure arranged to rest on the seabed and support a plurality of spaced turbine generators.

14. A method of controlling the speed of a rotational tidal turbine comprising a rotor and a plurality of turbine blades at a fixed attitude with respect to the rotor and extending outwardly from the rotor; wherein at least one parameter of the blades is arranged such that over the in-service operational speed range of the turbine, over a lower range of rotational or tidal flow speeds, increased speed results in increased axial loading on the turbine, but at higher speed range above a predetermined threshold, axial loading on the turbine does not increase.

15. A control system for a tidal flow turbine generator comprising a rotor and a plurality of turbine blades at a fixed attitude with respect to the rotor and extending outwardly from the rotor, the control system comprising:
means for configuring at least one parameter of the blades such that over the in-service operational speed range of the turbine, over a lower range of rotational or tidal flow speeds, increased speed results in increased axial loading on the turbine, but at higher speed range above a predetermined threshold, axial loading on the turbine does not increase.

16. A method of designing a tidal flow turbine system comprising a rotor and a plurality of turbine blades at a fixed attitude with respect to the rotor and extending outwardly from the rotor; wherein the stagger angle of the blades is selected such that over the in-service operational speed range of the turbine, over a lower range of rotational speeds, increased rotational speed results in increased axial loading on the turbine, but at higher speed range above a predetermined threshold, axial loading on the turbine does not increase.

17. A method according to claim 14, wherein:
at the higher speed range above the predetermined threshold, axial loading on the turbine decreases.

18. A method according to claim 14, wherein:
the one or more parameters of the blade are selected from the group including blade stagger angle and Tip Speed Ratio (TSR).

19. A control system according to claim 15, wherein:
at the higher speed range above the predetermined threshold, axial loading on the turbine decreases.

20. A control system according to claim 15, wherein:
the one or more parameters of the blade are selected from the group including blade stagger angle and Tip Speed Ratio (TSR).
